(19) United States
(12) Patent Application Publication
(10) Pub. No.: US 2004/0107182 A1
(43) Pub. Date: Jun. 3, 2004

(54) Information providing apparatus

(75) Inventor: Yukiko Yoshida, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/720,075

(22) Filed: Nov. 25, 2003

Related U.S. Application Data
(63) Continuation of application No. PCT/JP01/04511, filed on May 29, 2001.

(51) Int. Cl. G06F 7/00

(52) U.S. Cl. 707/1

(57) ABSTRACT

An information providing apparatus is provided that is for structuring and presenting the detailed information of an,event, reflecting the environmental conditions of the event and customized for each user, for various events relating to information such as a news article or a publicity (for example, systems fortax, pension, public service fees, services, etc).

### TECHNICAL FIELD

The present invention relates generally to an information providing apparatus that provides information to a user terminal through a network, and more particularly to an information providing apparatus for structuring and presenting detailed information capable of being customized for each user and that reflects environmental conditions for various events relating to information such as news articles and publicities.

### BACKGROUND ART

Since news articles and publicities distributed by newspapers, magazines and televisions target the general public as their readers or audience, they commonly do not carry very detailed information.

For the user (the reader of those news articles and publicities), what the user would like to know most when the user have read or heard the information is how certain information (the information obtained from the news articles or publicities) is related to his/herself. Therefore, the user often queries the information provider (a newspaper office, a television station or a publicity office) of the information by mail, fax, e-mail or on telephone to obtain the detailed information on conditions imposed by the user.

The information provider responses to such a query by mail, fax, e-mail or on telephone, or take a measure such as notifying the user of the queried information as supplementary information of the news through the newspaper or the television.

Furthermore, with the prevalence of the Internet, the Web is utilized more as a way of responding the query about news articles. It has become easier for users to retrieve information by themselves by using hyperlinks to related sites of the articles (in the case of news articles on a network), by adding URLs of related sites (in the case of conventional newspapers and magazines) or by providing pages for “Frequently Asked Questions and Answers” on the Web site of the news distributing company.

For the information provider, there are problems such as that responding to such a query needs time and personnel expenses and that the information provider may be adversely reputed among the users if it has failed in responding satisfactorily. Especially, it becomes more difficult to respond quickly with correct answers when combination optimization problems or numerical calculations are involved in the contents of query.

For example, a user would like to know detailed information such as “I hear telephone companies has set anew subscription system. I live in B City in C Prefecture. I frequently make calls to a friend of mine living in D City in E Prefecture and use the Internet for around ten (10) hours a month. What is the optimal combination of a telephone company and an Internet service provider. (ISP) for me (who would like to use the Internet for 30-50 hours a month when the conditions are preferable for me)?” or “I have read an article about the taxation system. I earn xxx yen a year and my wife earns yyy yen a year. We have a child going to a kindergarten and will have one more child within this year. For such a family, would you tell me the tax amount payable for this year and the amount of increase or decrease compared with that of last year?”, however, it is difficult to answer such queries quickly and correctly.

In the case where many queries having the same contents have rushed, the same answers have to be returned repeatedly and it is inefficient when the responses are returned in the conventional form such as being on the phone or by e-mail.

Furthermore, it is hard to know the relation between the news article and a related site linked from the article (i.e., from which piece of information the article has been written). Therefore, the detailed information may not be obtained easily.

Yet furthermore, the Web pages such as “Frequently Asked Questions and Answers” are not suitable for obtaining information customized for each user.

### DISCLOSURE OF THE INVENTION

It is therefore an object of the present invention to provide an information providing apparatus for structuring and presenting detailed information capable of being customized for each user and that reflects environmental conditions for various events such as the ones introduced in news articles and publicities.

In order to achieve the above object, according to a first aspect of the present invention there is provided an information providing apparatus that provides information to a terminal of a user through a network, comprising:

a storage unit for storing environmental conditions that are predetermined conditions for an event relating to information provided by a predetermined information provider;

a control unit for acquiring user conditions that are inputted by the user and that are the conditions relating to and specific to the user, from the terminal of the user through the network; and

a structuring unit for structuring, in conformity with the environmental conditions, detailed information that is the information corresponding to the user conditions relating for the event,

wherein the control unit distributes the detailed information to the terminal.

In a second aspect of the information providing apparatus according to the first aspect of the present invention, the storing unit stores the user conditions, wherein

after the user conditions are stored in the storing unit, the control unit extracts, in conformity with another request for the detailed information from the user, part corresponding to the user conditions stored in the storage unit, of other user conditions corresponding to the another request for the detailed information, and acquires part not corresponding thereto through an input by the user, and wherein

the extracted part can be changed by the user.

In a third aspect of the information providing apparatus according to the first aspect of the present invention, the structuring unit executes at least one (1) program for creating the detailed information.

In a fourth aspect of the information providing apparatus according to the first aspect of the present invention, the structuring unit has a plurality of programs for creating the detailed information, selects one (1) program in response to at least one (1) of the nature of the event, the environmental conditions and the user conditions and executes the selected program.

In a fifth aspect of the information providing apparatus according to the first aspect of the present invention, when a predetermined condition among the user conditions is not yet set, the structuring unit temporarily sets at least one (1) set value that the predetermined condition may take and creates the detailed information using the set value.

In a sixth aspect of the information providing apparatus according to the first aspect of the present invention, with the change of the environmental conditions, the structuring unit re-creates the detailed information about the event based on the changed environmental conditions at a timing designated by the user, and wherein

the communication unit distributes the re-created detailed information to the user.

Preferably, information provided by the information provider is a news article or a publicity provided over a network and the information providing apparatus is linked via a network with a site on the network for providing the news article or the publicity.

### BRIEF DESCRIPTION OF THE DRAWINGS

FIG. 1 is a diagram showing an example of the structure of an information providing apparatus according to an embodiment of the present invention;

FIG. 2 is a schematic process flowchart of the information providing apparatus according to the embodiment of the present invention;

FIG. 3 shows an example of output format of a detailed information structuring result;

FIG. 4 is a diagram showing an example of description of a template;

FIG. 5 is a diagram showing an example of description of a template;

FIG. 6 is a diagram showing an example of user attribute data;

FIG. 7 shows an example of a list of detailed-information structuring conditions inputted corresponding to a template;

FIG. 8 shows an example of detailed information displayed on a user terminal 40;

FIG. 9 shows examples of a plurality of problem solving programs;

FIG. 10 shows an example of detailed information structured corresponding to a plurality of temporary values for setting;

FIG. 11 is a diagram showing an example of an interface screen for an update information notification service;

FIG. 12 is a diagram showing an example of an interface screen corresponding to FIG. 11, to which input by user has been executed;

FIG. 13 is a diagram showing an example of an input form for query to an operator;

FIG. 14 is a diagram showing an example of filling-in of an input form corresponding to FIG. 13;

FIG. 15 is a diagram showing an example of returned e-mail;

FIG. 16 shows an example of a news providing site having thereto added a hyperlink to a detailed-information providing site; and

FIG. 17 shows an example of an article carrying an identifier and a portal site of a detailed-information providing site.

### BEST MODE FOR CARRYING OUT THE INVENTION

Embodiments of the present invention will now be described with reference to the drawings. However, the technical scope of the present invention is not limited to the embodiments.

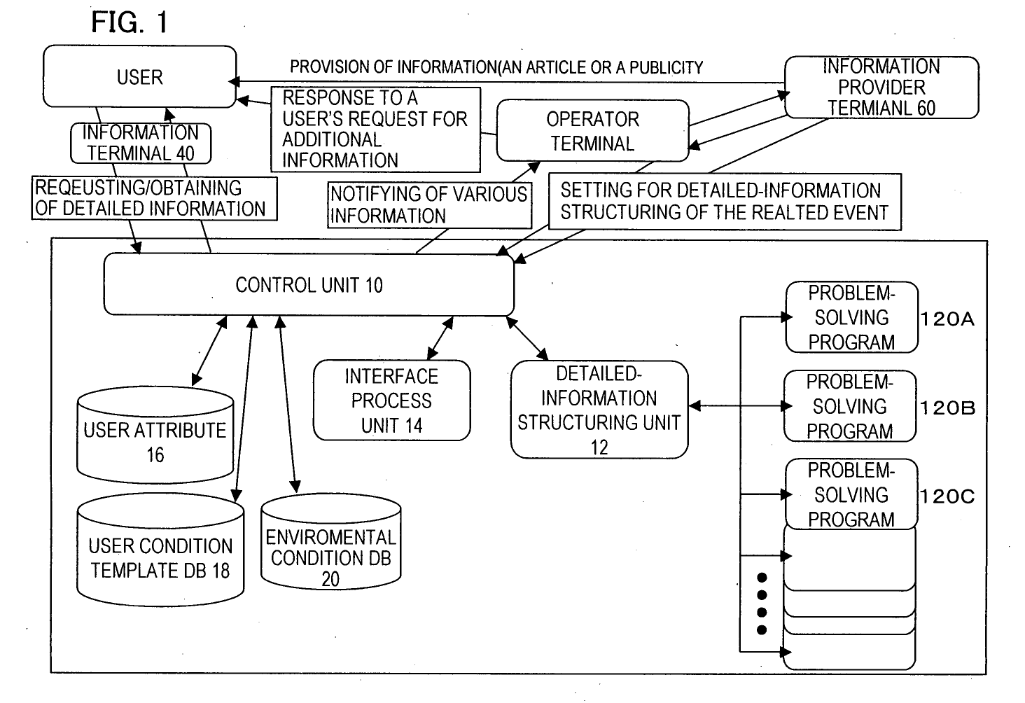

FIG. 1 is a diagram showing an example of the structure of an information providing apparatus according to an embodiment of the present invention. With the apparatus of the example of the structure shown in FIG. 1, the environmental conditions of the various events such as the ones introduced in news articles or publicities (for example, systems such as tax, pension, fees for public services and services) can be reflected to those events, and detailed information capable of being customized for each user can be structured and presented.

In FIG. 1, the information providing apparatus controls the whole detailed-information providing service and comprises a control unit 10 for executing communication through a network and a detailed-information structuring unit 12 for structuring detailed information customized for each user according to user conditions being the preconditions for structuring the detailed information and the environmental conditions. The control unit 10, as described later, also executes a registration process of user attributes (user conditions set by the user), a setting process of the environmental conditions for structuring the detailed information and the user conditions. The information providing apparatus further has an interface process unit 14 for creating an interface for operators and users, a user attribute database (DB) 16 for storing user attributes (the user conditions already registered), a user condition template DB 18 for storing input items (template) of the user conditions capable of being set by a user and an environmental condition DB 20 for storing the environmental conditions not capable of being set by a user. The detailed-information structuring unit 12 is integrated with some kinds of problem solving programs 120A, 120B . . . capable of being switched in response to structuring conditions of the detailed information. The information providing apparatus is connected through a network with an information terminal 40 of a user, a terminal 50 of an operator operating the information providing system and a terminal 60 of an information provider (for example, a news distribution company).

The information provider can make settings for structuring and providing the detailed information of events relating to the information to provide in news articles and publicity, to the information providing apparatus through an operator (on the side of the operator of the apparatus) or directly (utilizing the terminal 60) to those events.

Among the preconditions for structuring the detailed information of an event, the portion that each user can set is represented by a template (described later) constituted by a combination of the attribute, its data type, the possible range of the value and its default value as “user conditions”. “User conditions” are, for example, the place of the residence, income, hobbies etc. of a user.

On the other hand, among the preconditions for structuring the detailed information of an event, the portion not capable of being set by a user is given as “environmental conditions”. “Environmental conditions” are, for example, telephone charges determined by a telephone company, the taxation system determined by the national government or a local government etc.

When a user is using the detailed-information providing service, the attribute of the user (for example, age, sex, place of residence etc.) is registered in the user attribute DB 16. The user attribute constitutes the user conditions.

Each event is assigned with a site (detailed-information providing site) on a network, to which a user can make an access through its terminal 40 and can request and obtain the detailed information.

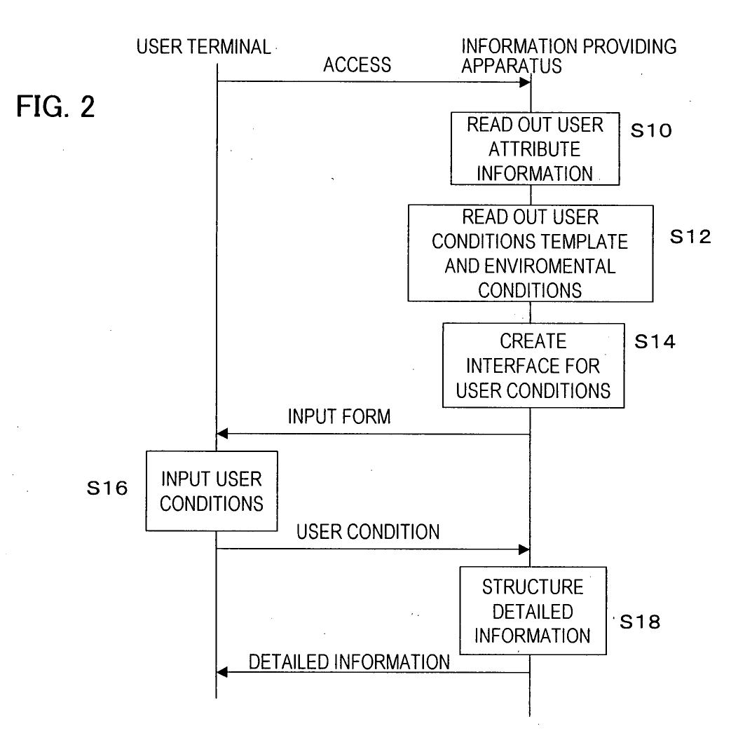

FIG. 2 is a schematic process flowchart of the information providing apparatus according to the embodiment of the present invention. In FIG. 2, first, when a user designates a URL of the detailed-information providing site and makes an access to the information providing apparatus, the control unit 10 identifies the user using the user ID and a password or a cookie etc. and reads out the attribute information of the user (registered user condition) from the user attribute DB 16 (S10).

Next, the control unit 10 reads out a template of user conditions corresponding to the event from the database 18 and reads out environmental conditions from the database 20 (S12). Furthermore, the control unit 10 extracts a portion corresponding to the template of the user conditions (referred to as [A]) from the read-out user attribute information and picks up a portion having not been registered in the user attribute DB 16 (referred to as [B]) from the template of the user conditions.

Next, the interface process unit 14 creates an interface (for example, an input form on a Web window) for these user conditions for setting conditions for structuring the detailed information (S14). During this, the above [A] is incorporated as a default condition of the user conditions relating to the user and, as to [B], an input column (such as a free-input column, a check box etc.) corresponding to the type of the data (in order for the user to input additionally some user conditions).

The input form is transmitted to the user terminal 40 and the user can input properly the user conditions not yet inputted (S16) and can change at that moment the user conditions provided with the default condition. The inputted information and the changed information are transmitted to the information providing apparatus.

The detailed-information structuring unit 12 of the information providing apparatus executes a predetermined problem-solving program based on the user conditions and the environmental conditions set as above, structures the detailed information (S12) and distributes the result to the terminal 40 of the user.

In the case where the user has not set a part of the user conditions being the detailed-information structuring condition, the detailed-information structuring unit 12 temporarily may set possible values at the part of the conditions not yet set in some combinations (or for all the possible values), structure detailed information for each of them, classify the result using the values for conditions not yet set and present it to the user. Otherwise, according to the situation, the unit 12 may add an explanatory note about the values of the conditions not yet set to the result of the structuring of such detailed information, and present it to the user.

The user can change the attribute values at once and, for every change, can obtain the detailed information from the information providing apparatus under the new conditions. For example, when the length of time to use the Internet in one month is varied in many ways, the length of the time to use can be varied to, for example, ten (10) 30 and 50 hours to check how the combination of a telephone company and a ISP changes.

In this manner, the newly inputted/changed user conditions can be additionally registered/updated in the user attribute DB 16 or also deleted after temporary use with the consent of the operator, the user or both.

The structuring of the detailed information of an event is regarded as classified as some typical problem solutions such as combination optimization, numerical calculation and pattern matching. Therefore, some problem-solving programs are incorporated in the detailed-information structuring unit 12 and are made ready for use of any one of them by switching properly among them in response to the nature of the given event (how the environmental conditions and the user conditions have been given).

The problem-solving programs are structured using the approaches for linear programming, rule-base reasoning, taboo search, the neural network etc. Depending on an event, a problem-solving program dedicated for the event may be structured and incorporated. Otherwise, a problem-solving program outside the system may be utilized through a network.

As to a specific event, when the information has been updated, the update information may be notified to users by email etc. at the timing designated by each user (for example, as soon as the information has been updated, daily, weekly or on a designated day).

On the detailed-information providing site, the term of validity can be set for an event or the detailed information.

In the case where a user can not obtain information sufficient in terms of kind and amount from the detailed-information providing site, the user can request an operator the lacked portion of the information using an “interface for requesting additional information”.

Having received such a request, the operator makes the information providing apparatus get ready for answering more properly to queries from users at the next time and later by correcting the information providing apparatus such that it can response to the user directly and create the lacked portion of the information,

In the case where news articles and publicities are provided on a network, a hyperlink to the detailed-information providing site for the event (that detailed information can be provided to) is added to the news articles or publicities. Thereby, a user who has viewed a new article or a publicity can make an access easily to the detailed-information providing site of the event using the hyperlink.

In the case where news articles and publicities are not provided on a network (for example, conventional newspaper and magazine etc.), the URL of the detailed-information providing site of the event is described in them. Thereby, users having seen the news article or publicity can make an access to the detailed-information providing site by designating the URL from an information terminal connected with the network.

A URL is described by a row of letters such as, for example, http://www.infosite.com/eventID00123456. However, when a user can be made to use a predetermined mechanical reader, the URL may be described in the format for the mechanical reading (bar code etc.).

In this case, the work of the user him/herself to input the URL may be omitted because the mechanical reader reads the code of the URL.

Taking into account users who do not like to designate a site with a mechanical row of letters such as http://www.infosite.com/eventID00123456, an identifier substituting for the URL of the detailed-information providing site of each event, for example, a combination of key words of the event such as “ZZ Newspaper, Feb. 13, 2001, a comparison of charges between telephone companies” may be used. In this case, the operator of the system may set up a “detailed-information providing portal site” linking the identifier of the event and the URL of the detailed-information providing site and get ready to make it possible for the user to make an access to the detailed information of the event from the portal site using the key words of the event.

The embodiments of the present invention will be described more specifically.

### First Embodiment

An example will be taken, in which detailed information is structured and provided for each user as to an event, “a comparison of charges between telephone companies” relating to an article (information) about a new telephone subscription system from a newspaper company (information provider).

This telephone subscription system is a system in which a telephone company to use is selected and subscription is made with it as to a fixed telephone of a user for each call-destination categories including local calls, long-distance calls, international calls etc. Some of the telephone companies provide options such as a discount of the telephone charge for some call-destinations specified by a user and a discount made for a combination subscription with a predetermined ISP.

The newspaper company would like to provide further from the original article a combination of telephone companies with the cheapest telephone charge according to the place of the fixed telephone specified by the user and the form of use of the telephone, as the detailed information, and makes subscription with the detailed-information providing service of the present invention.

The operator of the information providing apparatus assigns one (1) detailed-information providing site (for example, http://www.infosite.com/eventID00123456) to the event.

Next, the operator registers environmental conditions and user conditions relating to the event into databases 20 and 18. The environmental conditions relating to the event are service area of each telephone company, telephone charges, various options etc.

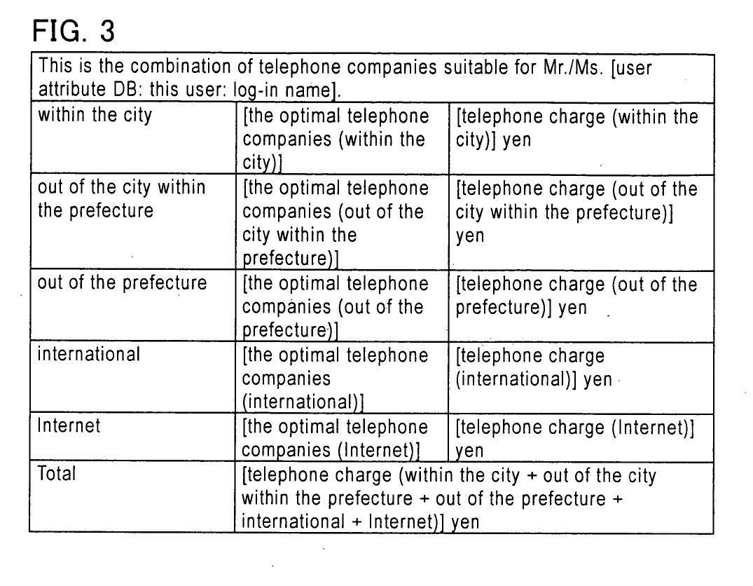

The output format of the result of the detailed-information structuring is also registered as an environmental condition. The output format is an aspect of display at the terminal 40 of the user and FIG. 3 is an example of the output format. In FIG. 3, values extracted from the user attribute DB and the result of the detailed-information structuring are described in [ . . . ].

The user conditions relating to the event are, for example:

1. the place of the fixed telephone (of the user);

2. main destinations of calls;

3. length of time for calls per one (1) month;

4. length of time to use the Internet per one (1) month;

5. Internet service provider (ISP); and

6. line for the Internet.

The combinations of [data type; range a value can take; default value] corresponding to the above items are:

1. [a row of letters (representing a name of an area) ; {a list of names of prefectures}, {a list of names of cities and villages}; the name of the area where the user lives], or [a row of letters (representing an area code of a telephone number); {area code}, {a prefix}; an area code of the telephone number of the user]

2. [a row of letters (representing a name of an area) ; {a list of names of prefectures}, {a list of names of cities and villages}; the names of the areas being the main call-destinations of the user} or [a row of letters (representing the area code of a telephone number); {area code}, {prefix}; the area codes of the main call-destinations of the user]

3. [a row of letters (representing the length of time of calls); {0-720 hours}; the length of time of calls of the user]

4. [a row of letters (representing a length of time); 0-720 hours}; the length of time to use the Internet for the user]

5. [a row of letters (representing the name of ISP); {a list of main ISPs}; the ISP of the user]

6. [a row of letters (representing the type of the line for the Internet); {“No”, “Analogue”, “ISDN”, “ADSL”, “FTTH”, “Mobile”, “others”}; the line for the Internet for the user]

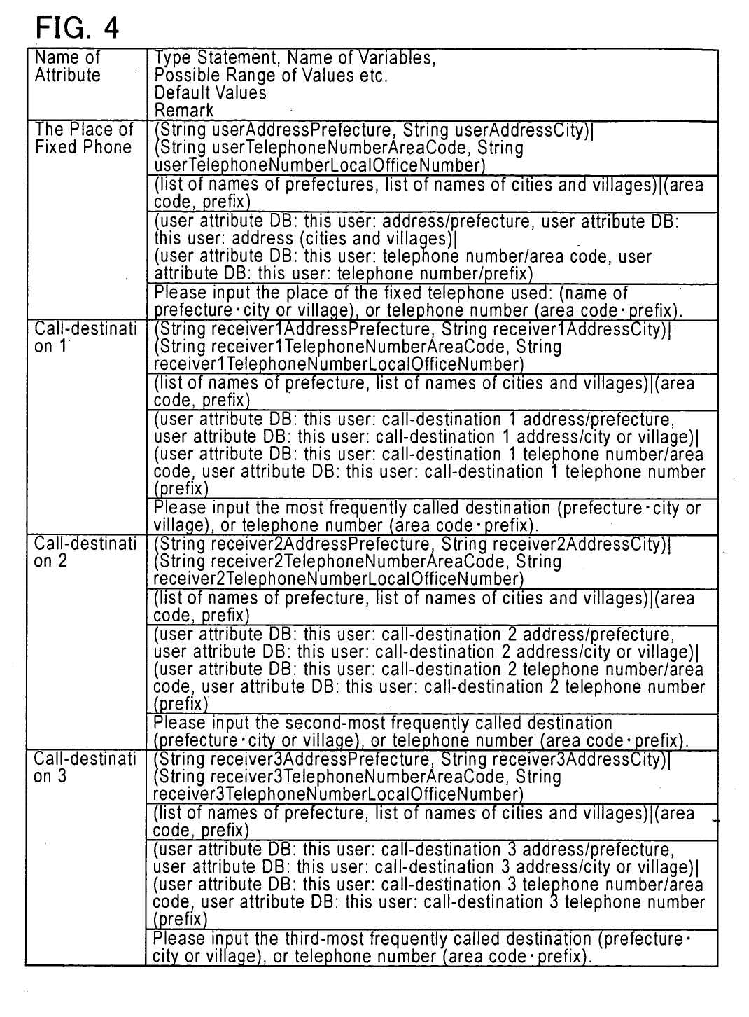

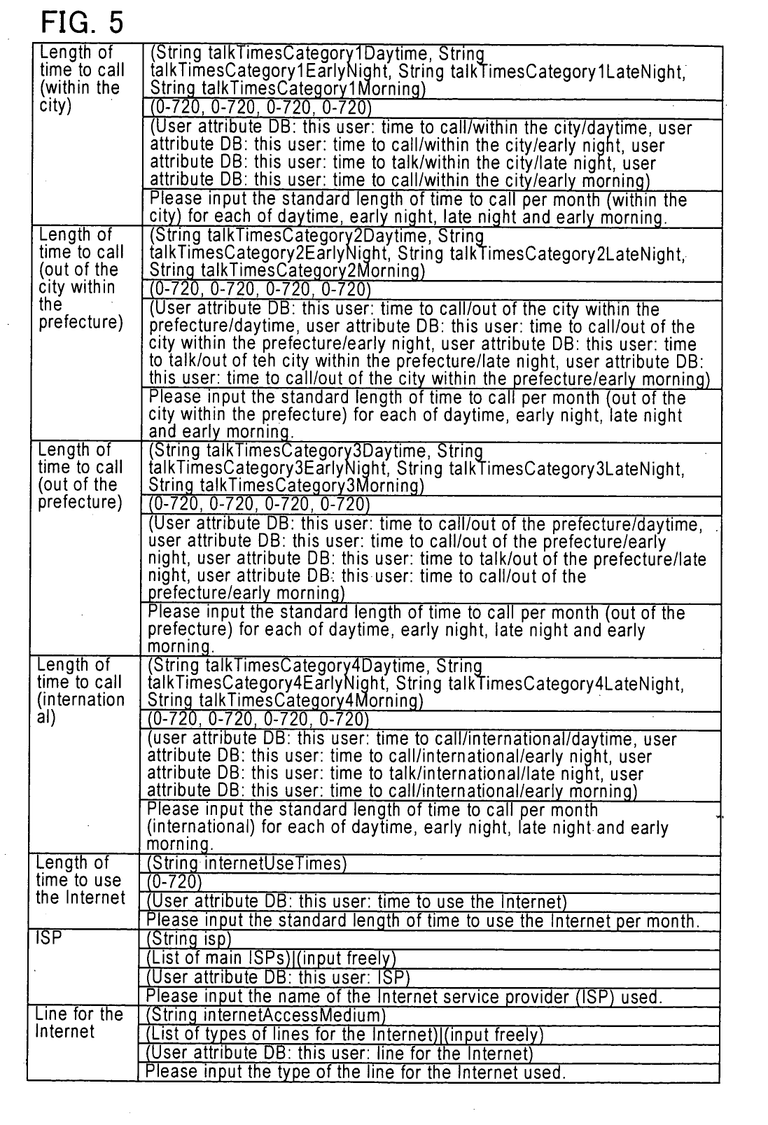

These user conditions are expressed as templates in a predetermined format to extract information from the user attribute DB and to structure an interface for setting the detailed-information structuring conditions. For example, they are described as follows. FIGS. 4 and 5 show examples of description for templates.

When a user makes an access to a detailed-information site of an event, the control unit 10 identifies this user using the user ID, a cookie etc. That is, the information providing apparatus issues a user ID, a cookie etc. for the user having made an access for the first time.

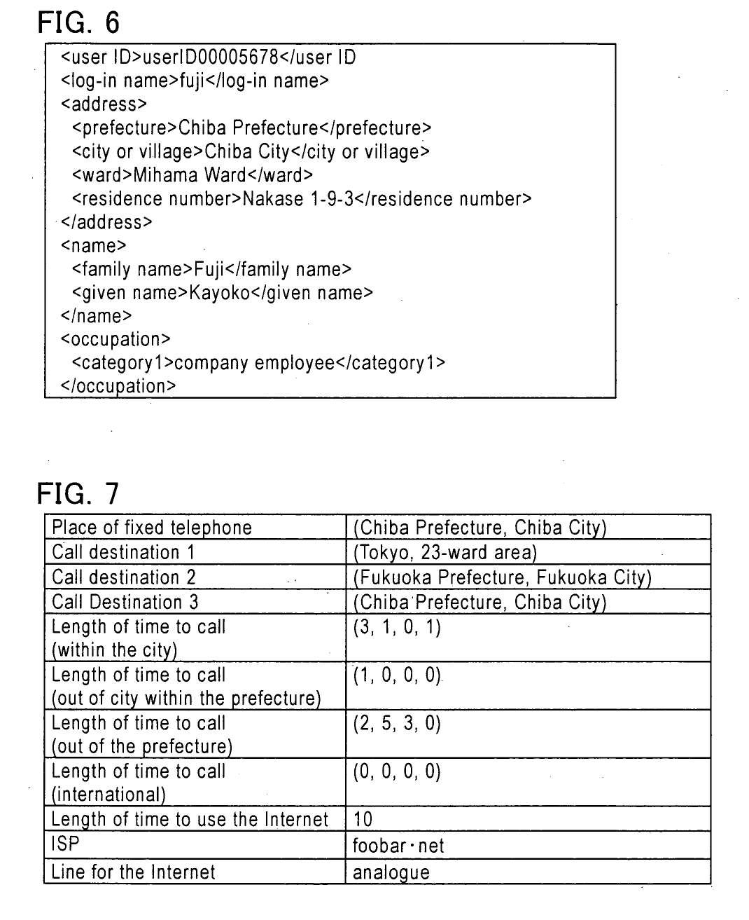

Having identified the user, the control unit 10 retrieves the attribute information of the user from the user attribute DB 16. In the embodiment, it is assumed that the user attribute DB 16 is described in XML format and, for example, data as shown in FIG. 6 are registered for the user.

The interface process unit 14 extracts information available as the default conditions of the detailed-information structuring from this user attribute information using the templates of the output format of the result of the above detailed-information structuring, and the user conditions. In this example,

login name: fuji

place of the fixed telephone (Chiba Prefecture, Chiba City) are extracted.

For this event (a comparison of charges between telephone companies), since the ID, name, occupation and name of ward in the address, residence number in the address of the user are unnecessary (not described in the templates) those pieces of information are not extracted.

Using the above templates, those conditions not registered in the user attribute DB 16 among the user conditions necessary for the detailed-information structuring are checked.

Then, the interface process unit 14 creates an interface for setting detailed-information structuring conditions for the user. For this creation, the above (Chiba Prefecture, Chiba City) is inputted as the default value in the column for the attribute, “the place of the fixed telephone”. For the attributes other than this, input columns such as pull-down menus for selecting items from the list and a free input column are created according to the above templates shown in FIGS. 4 and 5.

For example, for the input column of “call-destination 1” in FIG. 4, a pull-down menu presenting “a list of names of prefectures” and “a list names of cities and villages” for the user to select a suitable one as the first input method, and a free input column for the user to input “area code” and “prefix” as the second input method are created. As to the first input method, an implementation method is possible, in which, when a user has selected the name of one (1) prefecture from “a list of names of prefectures”, “a list of names of cities and villages” corresponding to that prefecture is structured.

The user inputs the value of the detailed-information structuring conditions using this interface. FIG. 7 shows an example of values of detailed-information structuring conditions inputted corresponding to the template.

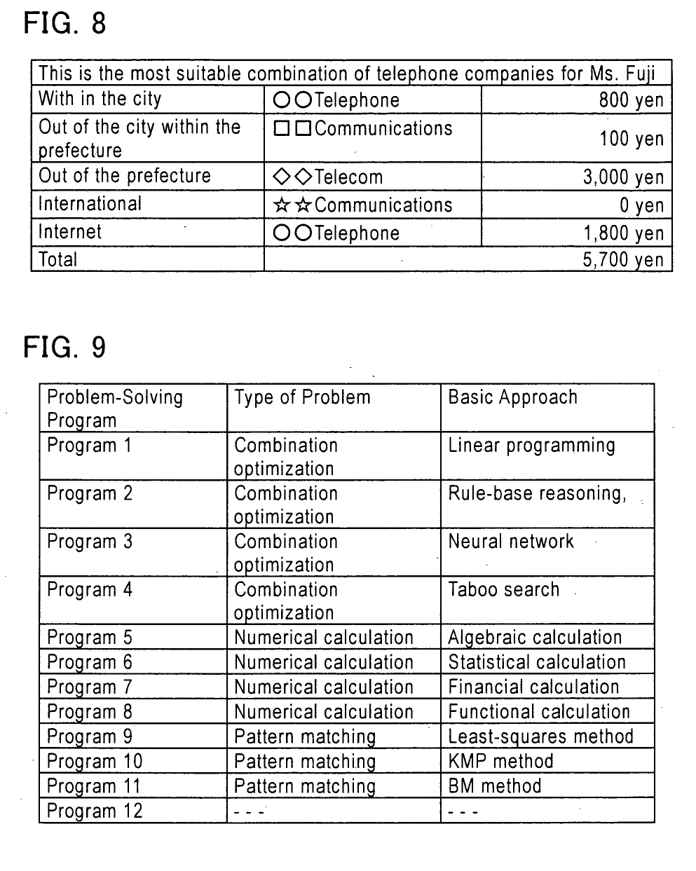

When the user has issued a execution order of detailed-information structuring (by, for example, pushing the “execution” button on the terminal), detailed-information structuring unit 12 of the information providing apparatus structures the detailed information based on the above conditions and present the result to the user in an output format set in the environmental conditions. FIG. 8 shows an example of detailed information displayed on a user terminal 40.

In this manner, according to the first embodiment, detailed information customized for each user can be provided easily from common information such as news articles and publicity. Furthermore, it becomes easy to describe conditions for the person who sets the problems by dividing the preconditions for structuring the detailed information for an event into environmental conditions and user conditions. Furthermore, it becomes easy to respond the updating of each of the environmental conditions and the user conditions. Yet furthermore, by expressing the user conditions by templates, when an interface for setting the detailed-information structuring for a user is structured, the process for extracting available information by necessary amount from the user attribute DB and the process for creating condition input columns corresponding to the data type of the preconditions become easy.

### Second Embodiment

An example in which the problem-solving programs in the detailed-information structuring unit are switched according to the nature of an event, the environmental conditions and the user conditions in the first embodiment.

A person structuring the system classifies the detailed-information structuring of an assumed event as some pieces of typical problem-solving, structures problem-solving programs corresponding to each of them and incorporates them into the detailed-information structuring unit 12.

FIG. 9 shows examples of a plurality of problem solving programs. When preconditions for detailed-information structuring are set for an event, problem-solving programs to be used are set in advance. For example, they are set as follows:

exploitation part of the optima, combination of telephone companies: Program 1, and

calculation part of telephone charges: Program 5.

After setting the conditions by the user, the problem-solving program to be used may be switched according to the value having been set. In this case, the switching method of the problem-solving program according to the value having been set of the user condition is described in the environmental conditions in advance.

Depending on the event, a problem-solving program dedicated to the event maybe structured, incorporated into the system and used. Furthermore, when a problem-solving program outside the system is available, it may be used through a network.

In this case, the information providing apparatus adapts the value having been set of detailed-information structuring conditions and the result of the detailed-information structuring by an external problem-solving program, to be properly converted according to the data input/output format of the external problem-solving program.

In the system structured in this manner, when the user sets the detailed-information structuring condition (in a manner same as in the first embodiment) and issues an execution order of the detailed-information structuring (by, for example, pushing the “execution” button), the detailed-information structuring unit 12 switches the problem-solving programs based on the above conditions and the detailed information is structured utilizing it and the result is presented to the user in a predetermined output format.

As described above, according to the second embodiment, in the detailed-information structuring unit, structuring of detailed information for various events may be coped with by switching and utilizing the various problem-solving programs such as combination optimization problems, numerical calculations, pattern matching etc. according to the nature of the event, environmental conditions and user conditions.

### Third Embodiment

A case will be described, where the user has not set a part of detailed-information structuring conditions in the first embodiment.

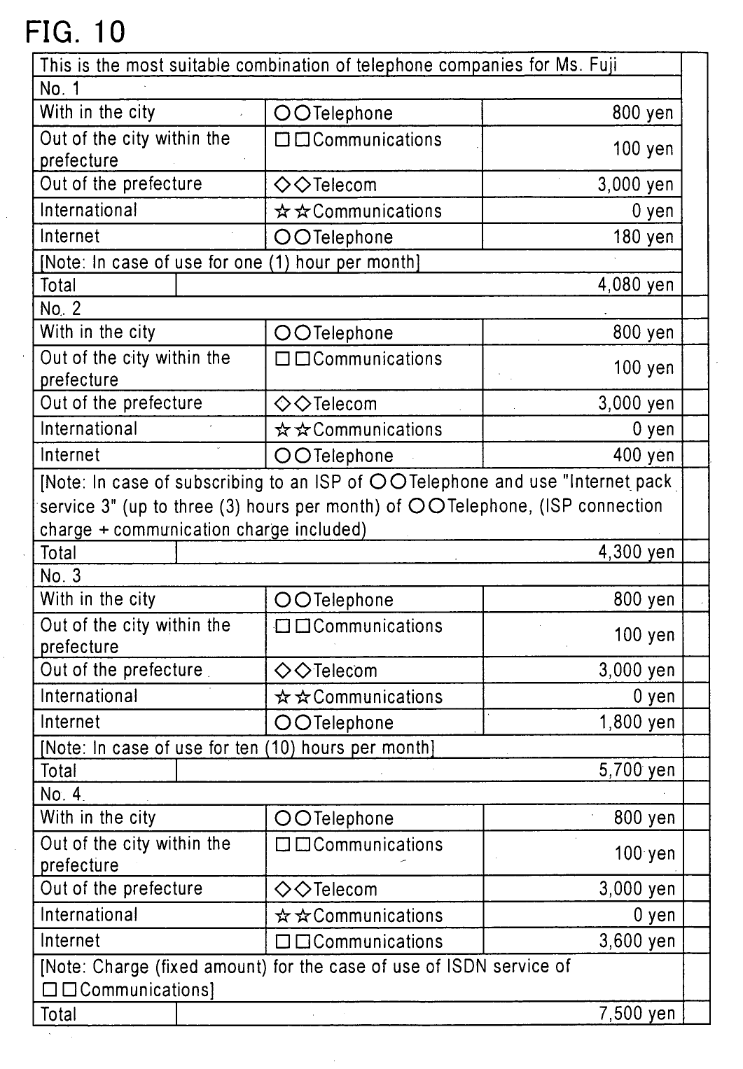

FIG. 10 shows an example of detailed information structured corresponding to a plurality of temporary values for setting. As shown in FIG. 10, for example, when the user has not fill in the input column, “length of time to use the Internet”, the detailed-information structuring unit 12 temporarily set the length of time to use the Internet in some ways (for example, one (1) hour, three (3) hours, ten (10) hours, 30 hours and 50 hours) and structures detailed information for each of those. Then, the unit 12 classifies the result based on the temporary set values, adds an explanatory note and presents it to the user.

As described above, according to the third embodiment, even when the user has not set a part of the detailed-information structuring conditions, the system supplements properly the values having not been set and the detailed information can be structured. Therefore, the user can select more freely whether to set/not to set the conditions. Furthermore, by classifying the result of the structuring according to the values of conditions not having been set and, when necessary, by presenting them with an explanatory note relating to the values of conditions not having been set, setting newly or changing the conditions referring to the result by the user is facilitated.

### Fourth Embodiment

An example will be described, in which re-structuring (updating) of the detailed information is executed at a timing designated by the user with the change of environmental conditions and the result is notified to the user in the first embodiment.

The operator registers in advance the input format of the settings (the timing for notifying, the destination of notifying) for providing the update information in a same manner as setting the preconditions of the detailed-information structuring.

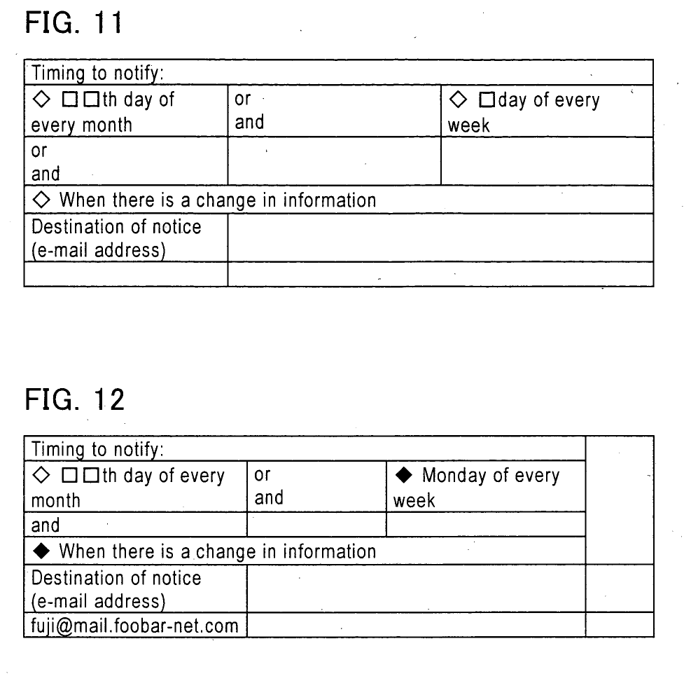

When the user has selected “update service notifying service” in the option menu of the detailed information site, an interface (an input column) as shown in FIG. 11 is created according to the input format of the settings for providing the update information registered by the operator and displayed on the terminal 40 of the user.

In FIG. 11, ⋄ is a check box (⋄ denotes “not selected” and ♦ denotes “selected”). As to “or/and”, either one of them has to be selected.

However, in this input format setting for various settings for providing the update information, when the e-mail address of the user has been registered in the user attribute DB, its value is included in the column, “destination for notifying (e-mail address)”.

FIG. 12 is an example of an interface screen corresponding to FIG. 11, to which input by user has been executed. In the case where the user would like to be notified the update information on the next coming Monday when there has been any change in the information, the user makes the check boxes of “⋄ every xx day of the week” and “⋄ when there is any change in the information” in this input column “selected” and selects “and” from the second input column, “or/and”. The user fills in “notifying destination” with his/her own e-mail address. This settings is registered in the user attribute DB 16 relating to this user.

When there is any change in the environmental conditions (for example, when there is any change in the charging system of a telephone company), according to this settings, the detailed-information structuring unit 12 executes re-structuring of the detailed information about this user on the next Monday and notifies the result to the user by e-mail.

In this manner, according to the fourth embodiment, with the change of the environmental conditions, re-structuring of the detailed information is executed and the result is notified to the user. Therefore, the user can easily obtain the change in the detailed information caused by the change in the environmental conditions. Since the notifying of the re-structuring of the detailed information and the result of it may be executed at the timing designated by the user, users who do not like to receive notices randomly can be coped with.

### Fifth Embodiment

An example will be described, in which the user requests additional information other than the information provided from the detailed-information providing site in the first embodiment.

Only the subscription of a fixed telephone is targeted as this event (a new telephone subscription system). Therefore, in this detailed information site, there is no items to be set for mobile phones (the operator has set in the preconditions accordingly).

However, this user suspects why items about mobile phones are not carried on this site, or why mobile phones are not targeted by the new system.

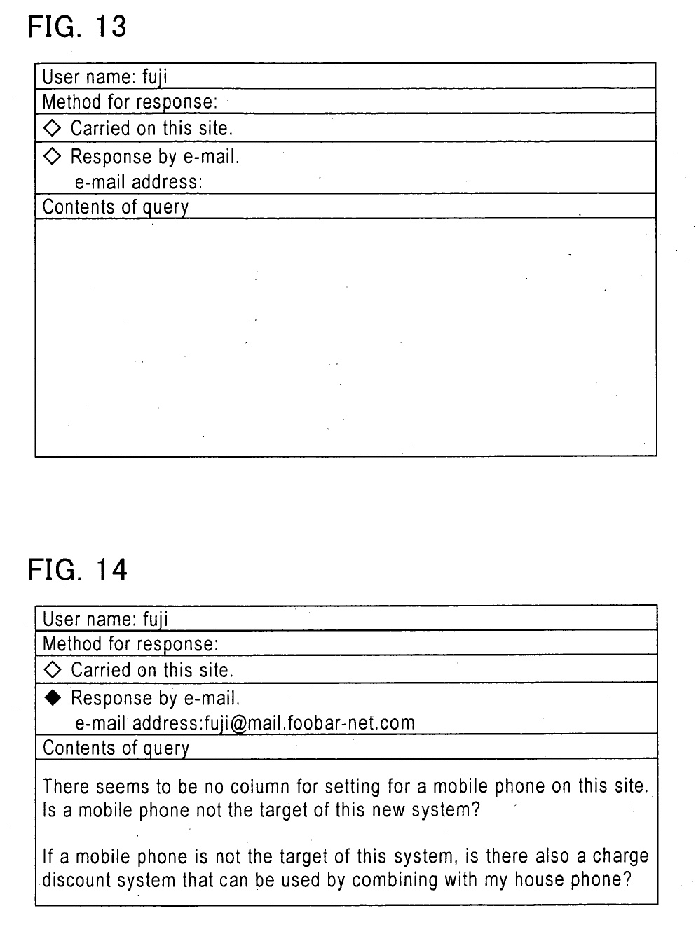

Then, this user selects “query to operator” in the option menu of the detailed information site. Then, the interface process unit 14 of the information providing apparatus creates an input form as shown in FIG. 13 and it is displayed on the terminal 40 of the user (when the e-mail address of this user is already registered in the user attribute DB 16, its value is included in the column, “e-mail address”).

The user selects “response by e-mail” in this input column, fills in the column, “e-mail address” with user's own address and fills in the contents of query. FIG. 14 is a diagram showing an example of filling-in of an input form corresponding to FIG. 13.

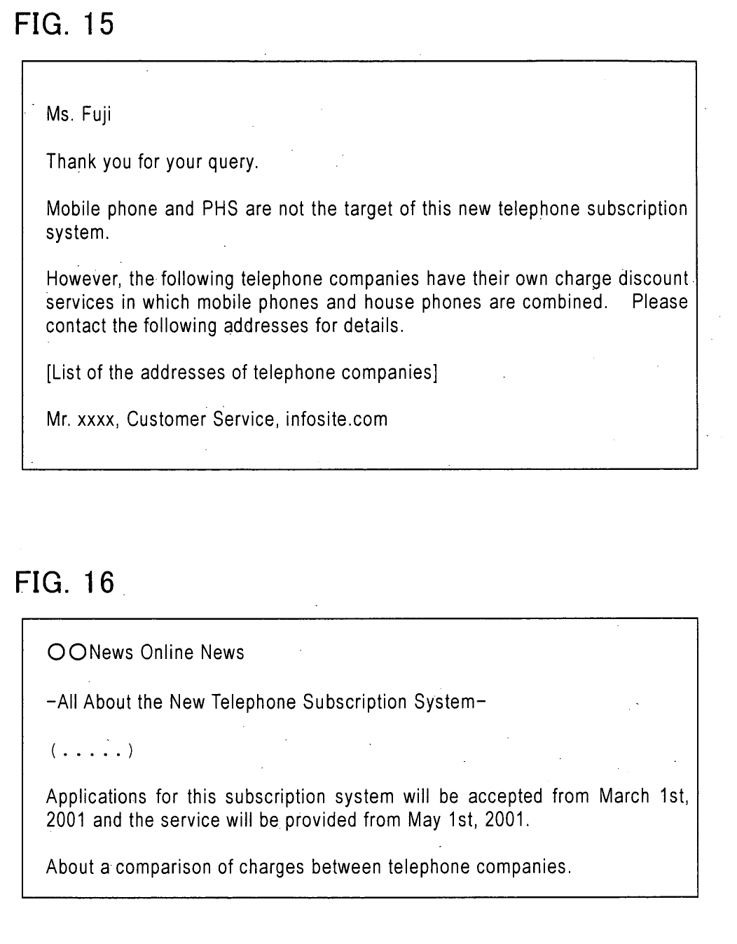

This contents are transmitted to the terminal 50 of the operator and the operator creates properly the response to the query and returns to the user by e-mail. FIG. 15 is a diagram showing an example of returned e-mail.

When queries having similar contents are received from many users, the operator may cause the contents of them to be carried in the Q&A of the detailed-information providing site by, for example, correcting and registering the preconditions of the detailed-information structuring. In this case, when the contents of the responses are different for each user, the contents of the responses are customized and displayed for a user as the user logs in this site.

Furthermore, since it has been found that people, like this user, are interested in the discount of the charge by subscription in which a mobile phone and a fixed telephone are combined regardless of the telephone subscription system, the operator corrects the template of the environmental conditions and the user conditions such that mobile phones can be handled on this detailed-information providing site.

As described above, according to the fifth embodiment, the user can send additional queries of the detailed information to the operator. Therefore, the operator may correct securely the contents of the detailed information capable of being provided in response of the request of the user.

### Sixth Embodiment

An example will be taken, in which a hyperlink to the detailed-information providing site of an event relating to a news article and a publicity provided on a network is added in the first embodiment.

An information provider (newspaper office, publicity etc.) adds a hyperlink to the detailed-information providing site for the event of a comparison of charges between telephone companies at, for example, the end of the article relating to the new telephone subscription system on the news providing site.

FIG. 16 shows an example of a news providing site added with a hyperlink to a detailed-information providing site. In FIG. 16, the position of “comparison of charges between telephone companies” is a hyperlink to the detailed-information providing site of the event, http://www.infosite.com/eventID00123456.

When the user clicks this hyperlink on the information terminal, the window jumps to the above detailed-information providing site.

### Seventh Embodiment

An example is described, in which an access is made to a detailed-information providing site of an even relating to a news article or publicity not provided on networks by specifying the URL or the identifier of the site on an information terminal by the user by inputting the URL or an identifier (substituting for the URL) of the site in the first embodiment.

In the case where an identifier is used in stead of a URL, the operator of the information providing apparatus sets up a “detailed-information providing portal site” linking the identifier of the event and the URL of the detailed-information providing site and gets ready to make an access to the detailed information of each event using the identifiers from the portal site.

The information provider (a newspaper office, a publicity office etc.) describes, for example, the identifier and the name of the portal site of the detailed information providing site about the event of a comparison of charges between telephone companies at the end of the article relating to a new telephone subscription system.

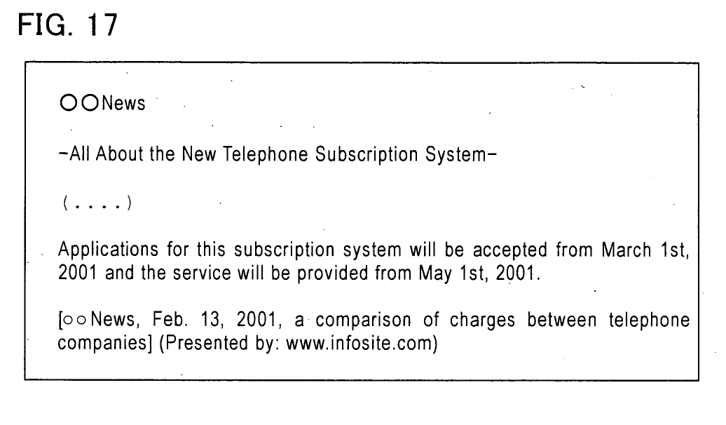

FIG. 17 shows an example of an article carrying the identifier and the portal site of the detailed-information providing site. In FIG. 17, “ZZ Newspaper, Feb. 13, 2001, a comparison of charges between telephone companies” is the identifier and corresponds to the detailed-information providing site of the event, http://www.infosite.com/eventID00123456.

The user first makes an access to the portal site, www.infosite.com using an information terminal connected with a network. From the site, an access can be made to the detailed-information providing site of the event using the key words of “ZZ Newspaper”, “Feb. 13, 2001”, and “a comparison of charges between telephone companies” as the clues. Certainly, the URL of the detailed-information providing site may be described directly.

As described above, according to the sixth and seventh embodiment, by adding a hyperlink linking to the detailed-information providing site of an event to a news article or a publicity, or by setting up a detailed-information providing portal site, an easy access means from the news article or the publicity to the detailed-information providing site may be provided (even when the means are provided on the network or not provided on the network).

The event is not limited to the example of a “comparison of charges between telephone companies” described above. For example, the event may be “course, selection of timetable” determining the optimal course and the optimal timetable in response to information being an advertisement of a culture school.

### Industrial Applicability

Information providers such as newspaper offices, television stations, publicity offices etc. can add value of detailed-information provision of the related event to the articles and publicities that they provide.

In this case, when a user finds an event that the user is interested in, in the articles or publicities, the user can obtain easily the detailed information of the event (besides, the information is customized for each user).

Furthermore, when a user has not inputted a part of the detailed-information structuring conditions, detailed information is provided as much as possible. Therefore, even a use who would not like to input certain types of attributes or who has not yet decided the specific values to input can utilize the services without hesitation.

According to these characteristics, the satisfaction of users to information providers can be increased and the number of users (subscribers) of the information providing service can be increased. Furthermore, information providers can reduce the costs for responding to the queries from users.

The scope of the present invention to be protected is not limited to the above embodiments but covers the invention as defined in the claims and their equivalents.

What is claimed is:

1. An information providing apparatus that provides information to a terminal of a user through a network, comprising:
a storage unit for storing environmental conditions that are predetermined conditions for an event relating to information provided by a predetermined information provider;
a control unit for acquiring user conditions that are inputted by the user and that are the conditions relating to and specific to the user, from the terminal of the user through the network; and
a structuring unit for structuring, in conformity with the environmental conditions, detailed information that is the information corresponding to the user conditions relating for the event, wherein
the control unit distributes the detailed information to the terminal.

2. The information providing apparatus according to claim 1, wherein
the storing unit stores the user conditions, wherein
after the user conditions are stored in the storing unit, the control unit extracts, in conformity with another request for the detailed information from the user, part corresponding to the user conditions stored in the storage unit, of other user conditions corresponding to the another request for the detailed information, and acquires part not corresponding thereto through an input by the user, and wherein
the extracted part can be changed by the user.

3. The information providing apparatus according to claim 1, wherein the structuring unit executes at least one program for creating the detailed information.

4. The information providing apparatus according to claim 1, wherein the structuring unit has a plurality of programs for creating the detailed information, selects one program in response to at least one of the nature of the event, the environmental conditions and the user conditions and executes the selected program.

5. The information providing apparatus according to claim 1, wherein, when a predetermined condition among the user conditions is not yet set, the structuring unit temporarily sets at least one set value that the predetermined condition may take and creates the detailed information using the set value.

6. The information providing apparatus according to claim 1, wherein, with the change of the environmental conditions, the structuring unit re-creates the detailed information about the event based on the changed environmental conditions at a timing designated by the user, and wherein
the communication unit distributes the re-created detailed information to the user.

7. The information providing apparatus according to claim 1, wherein information provided by the information provider is a news article or a publicity provided over a network.

8. The information providing apparatus according to claim 7, wherein the information providing apparatus is linked via a network with a site on the network for providing the news article or the publicity.
